(19) United States
(12) Patent Application Publication
(10) Pub. No.: US 2010/0079414 A1
(43) Pub. Date: Apr. 1, 2010

(54) APPARATUS, SYSTEMS, AND METHODS FOR AUTHENTICATION ON A PUBLICLY ACCESSED SHARED INTERACTIVE DIGITAL SURFACE

(76) Inventor: Andrew Rodney Ferlitsch, Camas, WA (US)

Correspondence Address: Duft Bornsen & Fishman, LLP, 1526 Spruce Street, Suite 302, Boulder, CO, 80302, US

(21) Appl. No.: 12/241,276

(22) Filed: Sep. 30, 2008

(51) Int. Cl. G06F 3/033; G06K 11/06

(52) U.S. Cl. 345/179; 178/19.01

(57) ABSTRACT

Apparatus, systems and methods for authentication of use by multiple personal digital devices (PDDs) of a publicly shared digital surface. The digital surface provides a displayed work area for each personal digital device (PDD) in communication with the digital surface. Each PDD establishes secured communication with the digital surface identified by a security token. Each PDD may include a stylus adapted to receive the security token for use in exchanges with the digital surface to thereby associate the exchange with the authenticated PDD with which it is coupled. Actions taken by a user of a stylus on the digital surface are authenticated based on the security token and based on the location of the stylus when the action is requested.

### BACKGROUND

1. Field of the Invention

The invention relates generally to collaborative computing environments and more specifically relates to methods and structure for user authentication and location tracking on a digital interactive surface for public, shared, use.

2. Discussion of Related Art

Community or collaborative computing environments have evolved from simplest information sharing architectures to ever more powerful and interactive paradigms. One currently popular collaborative computing environment provides for an interactive digital surface capable of displaying information from a user of the surface and capable of transmitting information to a user. The exchanges are typically wireless data exchanges using any of several well known wireless communication techniques.

A user may first access the shared digital surface by bringing his/her wireless device into proximity with the shared digital surface. For example a user may approach the shared digital surface with a notebook computer, personal digital assistant, a cell phone or “smart phone”. The user's device may couple to the digital surface using wired or wireless communications. When a wireless connection is established, a portion of the display screen of the digital surface (a workspace) may be allocated to that user. When the user departs the proximity of the digital surface, the connection is lost and the user's portion of the display screen of the shared digital surface is simply available for allocation to another user.

One exemplary use of such a shared digital surface may be in a classroom or training environment. Each student (i.e., user) is physically in the proximity of the shared display and is allocated a workspace portion thereof. Thus each student and the instructor may view progress of others and interact with other students involved in the same training by viewing screen portions of the shared digital display screen associated with each participant.

In such an exemplary application, the community environment is a closed set of pre-authorized users—i.e., students registered for a class or a training session, or a group of workers at an employer's premises. Security and authentication is not an important issue in such environments since all users are known to be within an authorized group to share information according to the needs of the application. By contrast, where a digital surface is publicly accessed by any variety of users, it may be inappropriate to allow various actions of sharing information. Where security and authentication is an issue such as in a publicly accessed digital surface, present systems for collaborative efforts using a shared digital surface are insufficient. They are incapable of authenticating a user and associating a space on the shared digital surface with a specific user and that user's permissions for access to shared information.

It is evident from the above discussion that a need exists for improved methods and systems for effective utilization of a shared digital surface in the context of public sharing.

### SUMMARY OF THE INVENTION

The present invention solves the above and other problems, thereby advancing the state of the useful arts, by providing methods and systems for authenticating a user's personal device for use with a shared digital surface and to associate each action of that device with the user's permissions and security requirements.

One aspect hereof provides apparatus for use with a publicly accessible digital surface to provide collaborative data processing among a plurality of users of the digital surface. The apparatus includes a personal digital device (PDD) adapted for storing and processing data for a user of the PDD. The PDD communicatively coupled with the digital surface. The apparatus further includes a stylus adapted for communication with the PDD and adapted for wireless communication with the digital surface. The stylus adapted to authenticate exchanges between the PDD and the shared digital surface initiated by the stylus in communications with the digital surface.

Another aspect hereof provides a system that includes a digital surface adapted for wireless communication with a plurality of personal digital devices (PDDs) and adapted to display information exchanged between the digital surface and each of the plurality of PDDs. The system also includes at least one PDD adapted to store and process information on behalf of a user of the PDD. Each PDD further includes a stylus adapted for wireless communication with the digital surface and communicatively coupled to its associated PDD. The digital surface and each PDD are adapted to exchange information to establish a security token associated with each PDD for exchanges of information among the plurality of PDDs through the digital surface. The stylus associated with each PDD is adapted to receive the security token from its associated PDD and is adapted to communicate the security token to the digital surface. The digital surface is adapted to detect the location on the digital surface of the stylus associated with each PDD and is adapted to receive the security token from the stylus associated with each PDD. The digital surface is adapted to receive actions from a stylus associated with each PDD and is adapted to authenticate a received action based on the location of the stylus and based on the security token received from the stylus.

Yet another aspect hereof provides a method operable a personal digital device (PDD) and a digital surface. The method includes communicatively coupling the PDD to the digital surface. The method then establishes, between the PDD and the digital surface, a security token associated with a session for exchange of information between the PDD and the digital surface. The security token is provided to a stylus device communicatively coupled with the PDD. The method also includes communicatively coupling the stylus with the digital surface and receiving the security token at the digital surface from the stylus. The location of the stylus on the digital surface is determined and actions communicated from the stylus to the digital surface are authenticated using the location of the stylus and the security token received from the stylus.

### BRIEF DESCRIPTION OF THE DRAWINGS

FIG. 1 is a block diagram of an exemplary system incorporating features and aspects hereof to provide secure authentication of multiple users of a shared digital surface.

FIG. 2 is a block diagram providing exemplary additional details of an exemplary personal digital device as shown in FIG. 1.

FIG. 3 is a block diagram providing exemplary additional details of an exemplary stylus as shown in FIG. 1.

FIG. 4 is a block diagram depicting an exemplary pixel of an exemplary digital surface as shown in FIG. 1.

FIGS. 5 and 6 are diagrams describing exemplary actions requested by a stylus coupled with a personal digital device interacting with a digital surface as in FIG. 1.

FIG. 7 provides flowcharts of exemplary methods in accordance with features and aspects hereof to provide secure authentication of multiple users of a shared digital surface.

### DETAILED DESCRIPTION OF THE DRAWINGS

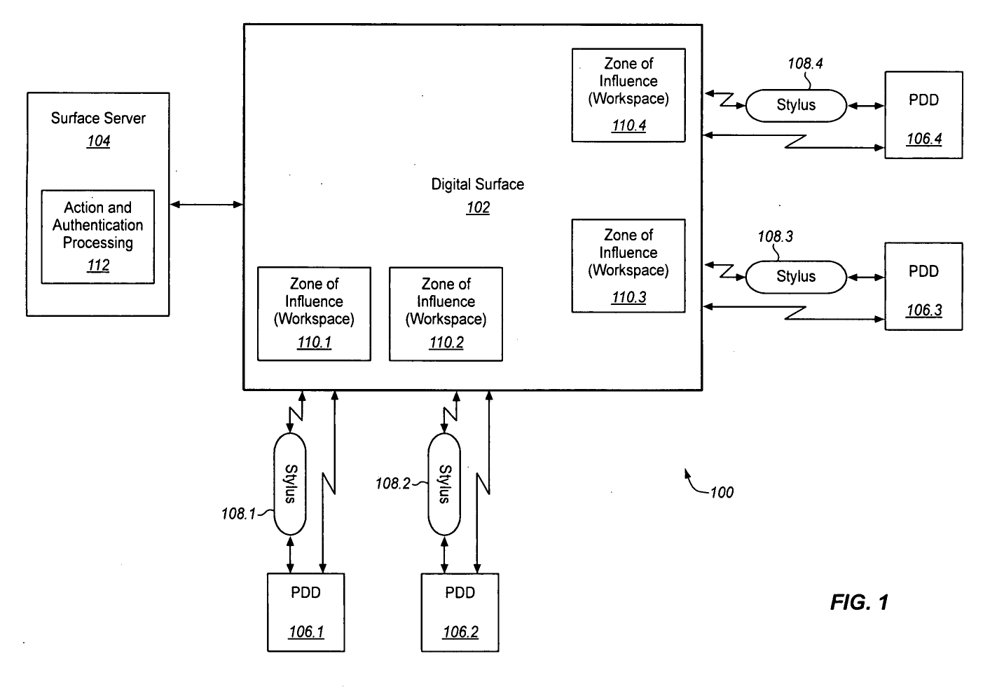

FIG. 1 is a block diagram showing an exemplary system 100 embodying features and aspects hereof providing for the authenticating use of a shared digital surface 102 by multiple personal digital devices 106. Shared digital surface 102 generally provides a large display surface on which each PDD 106 may be allocated an individualized workspace 110 (also referred to herein as a zone of influence). Server 104 controls operation of digital surface 102 and includes actions and authentication processing 112 to monitor and control action requests from users of the digital surface 102. Digital surface 102, in addition to providing display for each of the multiple PDDs 106 coupled to the digital surface, is adapted to exchange information with each of the PDDs 106 as well as from a stylus 108 associated with each PDD. For example, PDD 106.1 is adapted to communicate with digital surface 102 (under control of surface server 104) and is allocated a corresponding zone of influence 110.1. In addition, stylus 108.1 is communicatively coupled with PDD 106.1 and provides further communication with digital surface 102 as an extension of PDD 106.1. In like manner, PDD 106.2 and some corresponding stylus 108.2 communicate with digital surface 102 and utilize its corresponding allocated zone of influence 110.2, and so on for PDD 106.3, stylus 108.3, workspace 110.3; and PDD 106.4, stylus 108.4, and workspace 110.4.

When a PDD first couples with digital surface 102, the new PDD (e.g. 106.1 through 106.4) establishes communication through digital surface 102 with surface server 104. Exchanges between the new PDD and the digital surface 102 (under control of server 104) first establish a secure link utilizing, for example, the well known secure sockets layer (SSL) protocols. The exchange indentifies the new PDD to the digital surface and establishes a security token for use in communications throughout the session of interaction between the new PDD and digital surface 102. Once the security token is established, all subsequent communications between the digital surface 102 and the new PDD will utilize the security token to identify the PDD requesting the exchange and to authenticate the communication as associated with the particular, identified, new PDD. Further, the security token is utilized by the stylus associated with the new PDD such that all communications between the stylus and the digital surface are similarly authenticated as associated with the corresponding PDD. Thus, a user of the PDD is authenticated by the use of the security token established when the PDD first couples to the shared digital surface 102.

In one exemplary embodiment, a PDD may communicate with the digital surface 102 (under control of server 104) utilizing any of a variety of well-known wired or wireless communication techniques. For example, PDD 106.1 may identify itself to the digital surface using standard wired connections such as Ethernet or USB or using wireless connections such as near field communication (NFC) techniques including a barcode identifier or a radio frequency identification (RFID). In addition, other well known wireless techniques such as Wi-Fi, Bluetooth, and IrDA may be utilized for communication between the PDD 106.1 and digital surface 102. Similar wireless communication techniques may be utilized for communications between stylus 108.1 and corresponding PDD 106.1 as well as between stylus 108.1 and digital surface 102. In particular, in one exemplary embodiment of system 100, stylus 108.1 may communicate with its corresponding PDD 106.1 utilizing Bluetooth communications such that the stylus is in effect an extension of the PDD 106.1 in communications with digital surface 102. Stylus 108.1 may also utilize optical communication techniques in communicating between stylus 108.1 and the digital surface 102. Thus in one exemplary embodiment, digital surface 102 and each stylus 108 may each include optical emitter/sensor logic such that the stylus 108.1 and the digital surface 102 may exchange information utilizing optical communications.

By utilizing the security token established when the PDD first couples to the digital surface 102, all information exchanged through the corresponding stylus of a PDD may be associated with the corresponding user of the PDD. Action and authentication processing element 112 in server 104 may authenticate any requested action based on the security token to determine whether an action is allowed or disallowed on the shared digital surface 102. Thus an action by a user using stylus 108.1 on behalf of PDD 106.1 within the zone of influence 110.1 may be permitted while actions requested by a user of the same stylus 108.1 outside of its corresponding zone of influence 110.1 may be authenticated using the security token and either allowed or disallowed based on security rules implemented within action and authentication processing 112.

Further, any of the variety of well known communication techniques may be utilized in exchanges between a PDD 106 and its corresponding stylus 108, exchanges between the PDD 106 and the digital surface 102, and exchanges between the stylus 108 and digital surface 102. The location of a workspace 110 associated with a PDD 106 may be based, in part, on a location of the PDD 106 relative to the digital surface as determined, in part, by the communications used to couple the devices. For example, the PDD may couple to the digital surface utilizing a wired connection port of the digital surface 102 (under control of the server 104). The particular physical port to which the PDD is coupled may determine the positioning of the corresponding workspace 110 on the digital surface 102. When wireless communication techniques are employed for coupling of a PDD 106 to the digital surface 102 the proximity of the PDD to a particular area of the digital surface may be sensed through the wireless medium and protocols and the corresponding workspace 110 may be allocated on the digital surface 102 based on proximity of the PDD to the identified particular area of the digital surface 102.

Those of ordinary skill in the art will further recognize that any practical number of PDDs may be coupled with digital surface 102 (under control of server 104). Thus the particular number of PDDs shown in system 100 of FIG. 1 is intended merely as exemplary of one possible embodiment supporting multiple PDDs sharing access to digital surface 102.

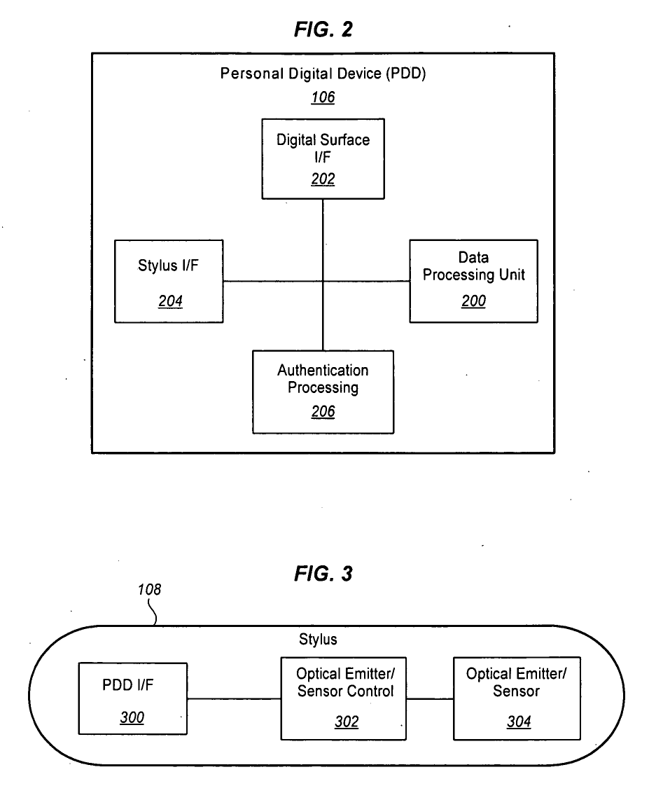

FIG. 2 is a block diagram depicting exemplary additional details of the structure of a PDD 106. PDD 106 may be any suitable personal data processing digital device including, for example, a portable computer (e.g., a laptop or notebook computer), a cell phone or “smart phone”, a personal digital assistant (PDA), etc. PDD 106 will generally include a data processing unit 200 providing some degree of personal computational processing power and associated memory for data and program storage. Data processing unit 200 controls overall operation of PDD 106 including its intended application for personal data processing and/or telephony operations.

In addition to the general data processing function performed by data processing unit 200, PDD 106 may include a digital surface interface 202 adapted for coupling the PDD 106 to a shared digital surface (e.g., digital surface 102 of FIG. 1). Digital surface interface 202 may provide wired or wireless communications capability with the digital surface. The digital surface interface 202, under control of data processing unit 200, identifies the PDD to the digital surface and exchanges information with the digital surface to establish a secure communication link. A security token is exchanged between the PDD 106 and the digital surface to identify the particular PDD (and hence its user) in all subsequent communications with the digital surface. Digital surface interface 202 may provide coupling between the PDD 106 and the digital surface utilizing any of the number of well-known wired and wireless communication media and protocols.

PDD 106 may also include stylus interface 204 for communicating with a stylus associated with the PDD. As noted above, the stylus is the preferred user device for communicating action requests to the digital surface. Stylus interface 204 therefore provides a communication interface between PDD 106 and its associated stylus device. Communications between PDD 106 and its associated stylus through stylus interface 204 may also use any of several well-known communication media and protocols.

Further, PDD 106 may include authentication processing 206 for establishing the secure communications with the digital surface either directly through digital surface interface 202 or by extension through the stylus and stylus interface 204. In particular, authentication processing 206 performs appropriate processing to initially establish the communication link between the PDD 106 and the digital surface including establishment of the secure communication link and the associated security token used for identifying and authenticating exchanges associated with this PDD 106. Those of ordinary skill in the art will readily recognize that authentication processing 206 may represent a distinct, separate circuit within PDD 106 or may simply be integrated as a function within the general-purpose processing features of data processing unit 200. In like manner, all elements shown in FIG. 2 may be integrated within a single integrated circuit or may be distributed among a plurality of integrated circuits or discrete components. Such design choices are readily apparent to those of ordinary skill in the art.

FIG. 3 is a block diagram depicting an exemplary stylus 108 used as an extension of the PDD 106 in communicating with the digital surface. Stylus 108 may be any suitable physical device including, for example, a pen or stylus structure as well as a traditional pointer or mouse device. Stylus 108 includes PDD interface 304 coupling the stylus 108 to its associated PDD 106. As noted above, communications between the PDD and the stylus 108 may utilize any of several well-known wireless communication techniques including, for example, Bluetooth and IrDA. Stylus 108 further includes appropriate communication means for communicatively coupling stylus 108 to the digital surface for exchange of information and in particular for requesting actions and receiving corresponding responses from the digital surface. In one exemplary embodiment, optical communication techniques and structures are used to exchange information between the stylus 108 and the digital surface. Thus, stylus 108 as exemplified in FIG. 3 may include an optical emitter/sensor element 304 and corresponding optical emitter/sensor control logic 302. Such an optical communication link coupled with corresponding optical emitter/sensor elements in the digital surface allows the exchange of information between the stylus (as an extension of the PDD) and the digital surface. As noted above, in all such exchanges, the stylus 108 may utilize the security token established in the secure communication link between the PDD and the digital surface to identify the stylus as associated with the corresponding PDD and hence its user.

Those of ordinary skill in the art will readily recognize that stylus 108 of FIG. 3 and PDD 106 of FIG. 2 may be separate devices coupled through a suitable communication link or may be integral with one another such that a PDD 106 may incorporate the optical emitter/sensor elements of stylus 108 in a single, integrated device. Still further those of ordinary skill in the art will readily recognize various additional and equivalent elements within a fully functional PDD 106 of FIG. 2 and stylus 108 of FIG. 3. Such additional and equivalent elements are omitted herein for simplicity and brevity of this discussion.

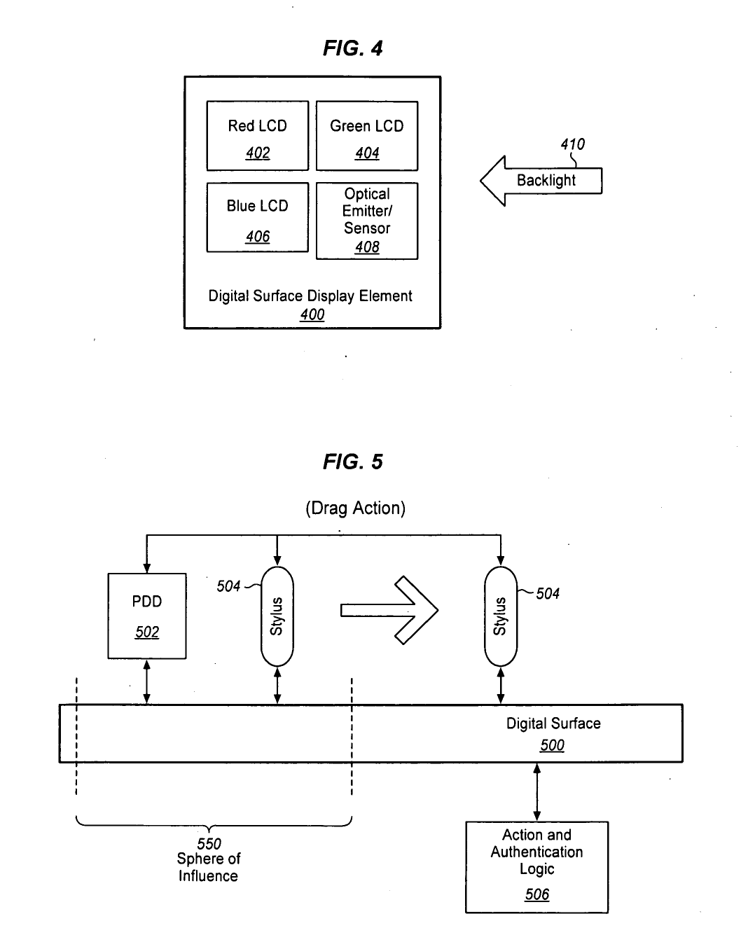

As noted above, the digital surface provides not only a common display shared by multiple users through their respective PDDs (and corresponding styli) but also provides a bidirectional communication link for exchange of information between the digital surface and the PDD through its stylus as an extension of the PDD. As further noted above, in one exemplary embodiment, the stylus (as an extension of the PDD) and the digital surface may communicate utilizing optical communication techniques and structures. The digital surface may be comprised of a two dimensional array of pixels for display purposes and each pixel may include appropriate optical emitter/sensor logic for communications with the corresponding optical emitter/sensor logic within the stylus of a corresponding PDD. FIG. 4 is a block diagram of an exemplary pixel 400 in an exemplary digital surface that provides both a color display capability and an optical communication capability. Each pixel 400 of the digital surface may include an appropriate red, green, and blue LCD element (402, 404, and 406, respectively). A backlight 410 illuminates the colored LCD elements 402, 404, and 406 to present the desired color display for the corresponding pixel 400. Optical emitter/sensor element 408 in each pixel 400 is used for transmitting and receiving data via optical signals exchanged with a stylus having corresponding optical emitter/sensor elements as discussed above with respect to FIG. 3.

In operation of the digital surface, a stylus is utilized by a user to point at a position of the display and to request an action to be performed on some displayed object at that position. The requested action is transmitted from the stylus to the digital surface as a message utilizing the optical emitter/sensor elements in the stylus and the digital surface. The optical signals are sensed or received by one or more optical emitter/sensor elements 408 in one or more pixel pixels 400 of the digital surface. The emitted optical signals from the stylus may actuate the optical emitter/sensor element 408 of multiple pixels 400 in the display surface in the vicinity at which the user is holding the stylus. One or more of the received optical signals from the one or more actuated pixels 400 will be decoded to receive the action request message. Further, by determining which pixels 400 in the two-dimensional array of pixels of the digital surface have been actuated, the location of the stylus the on the digital surface may be determined (within a small range of adjacent pixel pixels 400). Still further, since the message received from the stylus will include the security token assigned to its corresponding PDD, the digital surface (under control of its server computing node) may identify which stylus and thus which PDD and user is requesting a particular action. The digital surface (under control of its server computing node) may respond to the action requested by the stylus by indicating that the action is allowed or disallowed based on security rules and application of the security token received with the request. The return transmission is generated by the optical emitter/sensor element 408 of multiple pixels in the vicinity of the current location of the stylus and is thus received or sensed by the stylus optical emitter/sensor elements and forwarded to the PDD for appropriate processing. An exemplary digital surface having a display screen with optical emitter/sensors incorporated with each pixel is available from Sharp Corporation of Japan (such as discussed at http://www.sharp.co.jp/).

Exemplary of actions that may be requested by a PDD through such optical communication exchanges are typical graphical user interface (GUI) actions such as: click, drag, drop, grab, cut, copy, paste, etc.—actions typical of a GUI on any display surface (such as may be performed locally on the display screen of the PDD per se). As noted above, each PDD has an associated workspace or sphere of influence within which it may perform any actions through its stylus in communication with the digital surface. In general, the sphere of influence is a portion of the display of the digital surface assigned to the PDD in which displayed objects of the associated PDD are presented for shared viewing by all users of the shared digital surface. Within the sphere of influence associated with the PDD, a user through its stylus may request any appropriate actions to click, grab, drag, drop, copy, cut, paste, etc. If a user of a PDD points the stylus to an area of the digital surface outside of its corresponding sphere of influence, the action and authorization processing of the digital surface (through its associated server) will detect that the action request is presently outside of the sphere of influence of the corresponding PDD and refuse to allow or authorize the action based on authorization rules associated with the system. The particular authorization rules may be application dependent but are generally well known to those of ordinary skill in the computing arts. For example, standard network permission rules for multiple users in a network may determine what objects are intended to be accessible by others outside of a particular user's sphere of influence. Similar types of rules may be encoded by the server controlling the digital surface.

FIG. 5 is a diagram depicting an exemplary action requested by a user of PDD 502 through its stylus 504 interacting with digital surface 500. The sphere of influence 550 (e.g., workspace area of the digital surface 500 allocated to PDD 502) is denoted by the vertical dashed lines intersecting a portion of the digital surface 500. In the example of FIG. 5, a drag action was requested by PDD 502. Stylus 504 is first actuated within the sphere of influence 550 of PDD 502 to click or select an object within the sphere of influence 550 and to drag the object to another location on the digital surface 500 outside of the sphere of influence 550. The second location of stylus 504 is shown to the right of the initial position of stylus 504 with a large arrow indicating the drag action requested. Action and authentication logic 506 (within the server associated with digital surface 500) detects the requested action and authenticates that the request is in fact from PDD 502 through the security token provided with the drag action request from stylus 504. Presuming for this example that the user of PDD 502 has authorized the particular object to be dragged outside of its sphere of influence 550, action and authentication logic 506 authorizes the action and permits the object to be dragged to another location on digital surface 500 outside of the sphere of influence 550 (e.g., to be shared with other users).

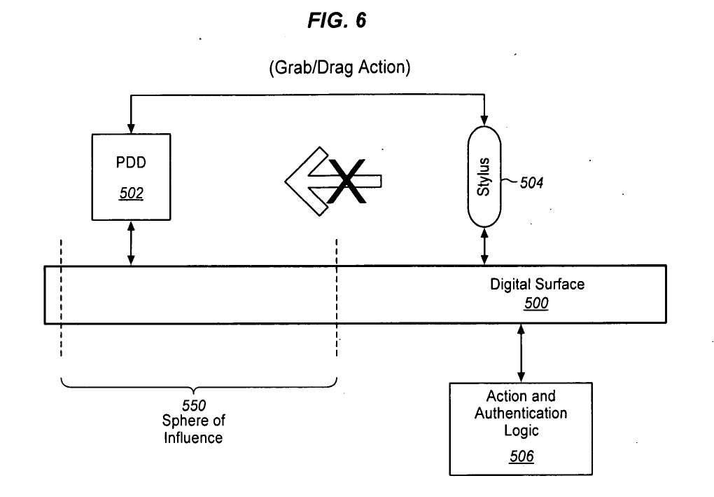

FIG. 6 is a diagram depicting another exemplary action requested by a user of PDD 502 through its stylus 504 interacting with digital surface 500. The sphere of influence 550 associated with PDD 502 is denoted by the vertical dashed lines intersecting a portion of the digital surface 500. In the exemplary action a FIG. 6, the user of PDD 502 positions its stylus 504 outside of the sphere of influence 550 associated with PDD 502 and requests a grab or drag action for an object outside of its sphere of influence back into its sphere of influence 550 (as indicated by the large arrow pointing left from the stylus position). The security token provided in the request by stylus 504 is received by action and authentication logic 506 through digital surface 500. Based on the security token provided and the authentication rules, action and authentication logic 506 will deny the requested action as indicated by the large “X” crossing out the arrow directed to the left requesting that the object be dragged from its initial position outside of sphere of influence 550 into the sphere of influence 550.

Those of ordinary skill in the art will readily recognize a wide variety of actions that may be requested by a user of the PDD 502 through its stylus 504 and corresponding authentication rules to validate the authority of a user to perform the requested action based on the sphere of influence defined by each PDD was and based on the rules for the particular application of the digital surface.

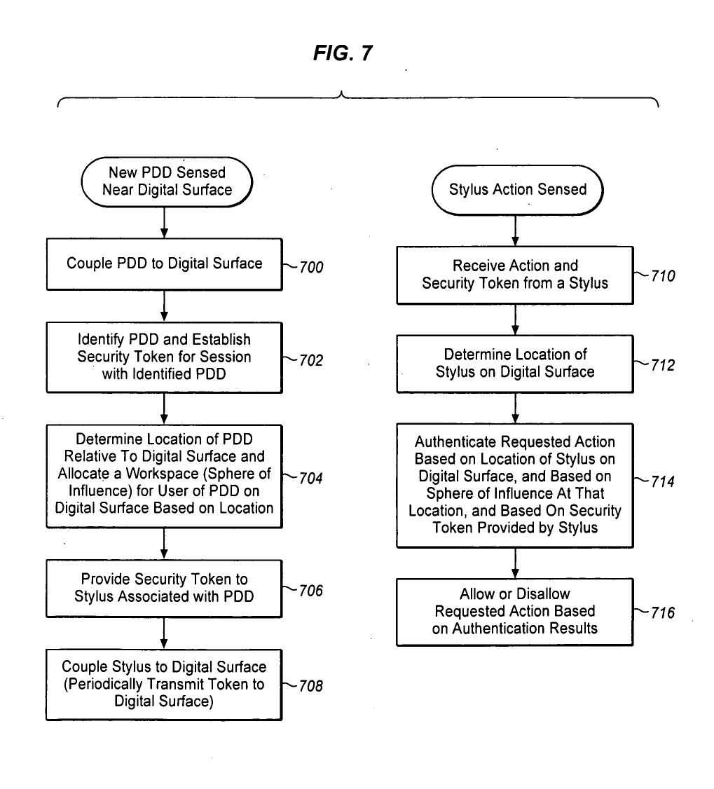

FIG. 7 provides flowcharts describing exemplary methods in accordance with features and aspects hereof to provide authentication of user requested actions on a shared digital surface. Steps 700 through 708 represent a method for coupling a newly sensed PDD to the digital surface. Steps 710 through 716 represent a method for sensing and processing an action request received from a PDD presently coupled to the digital surface.

When a PDD not presently coupled with the digital surface is detected or sensed as present at the digital surface, step 700 first couples the PDD to the digital surface by negotiating a secure link for communication exchanges between the newly sensed PDD and the digital surface. Sensing the presence of a new PDD near the digital surface may be performed in accordance with the particular communication medium protocol selected for coupling the PDD to the digital surface. For example, where a wired connection is utilized between the PDD and the digital surface, sensing the PDD plugged into a connector of the digital surface may suffice to detect the presence of a new PDD near the digital surface. Where wireless communication techniques are utilized, appropriate radio frequency or optical signal detection may be used to sense the presence of a new PDD near the digital surface.

Once a secure communication link has been established by step 700, step 702 represents processing to obtain the identity of the newly sensed PDD and establish the security token utilized for the duration of the session in communications between the identified PDD and the digital surface. Step 704 then determines the location of the PDD relative to the digital surface and allocates a workspace (sphere of influence) for the user of that PDD on the display of the digital surface based on the determined location of the PDD relative to the digital surface. As noted above, where wired communications are utilized between the PDD in the digital surface, the location of the workspace may be determined based on the physical connector by which the PDD is coupled to the digital surface. Where wireless communication techniques are employed, other well-known locating techniques used by wireless communication technologies may determine the approximate location of the PDD relative to the digital surface and thereby determine a preferred location for the workspace to be allocated for the newly sensed PDD. For example, where optical communication techniques are utilized between the PDD in the digital surface, the particular optical sensors on the digital surface that sense the presence of the new PDD may determine the approximate location of the PDD relative to the digital surface. Other known techniques of determining the location of a PDD or stylus on a digital surface are exemplified by the Microsoft Surface Computer in which cameras are integrated within a glass plane above the display surface such that the cameras can detect objects placed on the surface.

Step 706 then provides the security token to the stylus associated with the PDD to be used in further communications between the PDD/stylus and the digital surface. As noted above, where the stylus functionality is integral within the PDD the security token is readily available to all functionality within the PDD and thus step 706 relates primarily to configurations in which the stylus is separate and distinct from the PDD but coupled communicatively coupled thereto. Lastly, step 708 establishes appropriate communication between the stylus and the digital surface. Where optical communications are utilized, no particular processing is required to establish a communication link between the stylus and the digital surface. Where other wireless communications are utilized such as radio frequency communications, a secure link may be established between the stylus and the digital surface utilizing the security token already established for the PDD. Thus the stylus represents an extension of the PDD in communications with the digital surface. In particular, step 708 may include processing by the stylus (and/or the PDD per se) to periodically transmit the security token to the digital surface. Utilizing such periodic transmissions, the digital surface may maintain an up-to-date present location of the stylus on the digital surface for purposes of authenticating subsequent action requests and for displaying a cursor or other icon representing the stylus on the display of the digital surface.

Where multiple PDDs are in communication with the digital surface, each PDD/digital surface coupling performs the same method steps as described above for establishing communication between a newly sensed PDD in the digital surface. Thus any practical number of PDDs may establish communications with the digital surface as determined by the particular application.

Steps 710 to 716 represent an exemplary method for receiving and processing an action request from the stylus corresponding to a PDD already coupled to the digital surface. Step 710 represents receipt of an action request from a stylus. The action request includes the security token for the PDD to which the stylus is communicatively coupled and thus identifies the PDD (and hence the user of the PDD). As noted above, the action request may include any one or more of several well-known graphical user interface actions including, for example, drag, drop, grab, cut, paste, click, copy, etc. Step 712 next determines the present location of the stylus on the digital surface. As noted above, in one embodiment of the invention, optical emitter/sensor communications couple the stylus to the digital surface such that data may be exchanged and also provide a means for determining the location of the stylus on the digital surface based on which pixels of the two dimensional array of pixels in the digital surface sense the presence of the stylus. Where other wireless communication mechanisms are utilized between the stylus and the digital surface, other techniques and mechanisms may be utilized for determining the present location of the stylus on the digital surface as well known to those of ordinary skill in the art.

Having received an action request and a security token identifying the PDD, and having determined the present location of the stylus on the digital surface, step 714 authenticates the requested action based on the present location of the stylus on the digital surface, based on the sphere of influence at the present location of the stylus, and based on the security token provided by the stylus in conjunction with the received action request. Step 716 then allows or disallows the requested action based on the results of the authentication of step 714. As noted above, a variety of rules and permissions may be specified to determine what, if any, actions may be allowed by a stylus outside of the sphere of influence associated with the corresponding PDD. If the action is allowed, appropriate communications between the PDD and the digital surface effectuate the desired action (e.g., grabbing, dragging, dropping an object, etc.). If the requested action is disallowed based on the authentication results, an appropriate response is returned through the stylus to the PDD and the PDD will take appropriate action to notify the user that the requested action has been disallowed.

Those of ordinary skill in the art will readily recognize various additional and equivalent steps in a method such as that of FIG. 7. Such additional and equivalent steps are omitted herein for simplicity and brevity of this discussion.

Still further, those of ordinary skill in the art will recognize that in many applications, it may be advantageous to enable the size of the sphere of influence to grow and shrink based on parameters and status of the particular application of the shared digital surface. The size of the sphere of influence is not necessarily uniform across all PDD users sharing the digital surface, between multiple sessions by the same user, or even during a single session. These variations in the size of the sphere of influence could be for a variety of reasons. For example, the user may purchase (virtual or real currency) or earn (credits) additionally space for his/her sphere of influence. In the later case, for example, a user may be earning credits in a game playing role, where his/hers sphere of influence may grow/shrink as credits are earned and consumed.

While the invention has been illustrated and described in the drawings and foregoing description, such illustration and description is to be considered as exemplary and not restrictive in character. Various embodiments of the invention and minor variants thereof have been shown and described. In particular, those of ordinary skill in the art will readily recognize that exemplary methods discussed above may be implemented as suitably programmed instructions executed by a general or special purpose programmable processor or may be implemented as equivalent custom logic circuits including combinatorial and/or sequential logic elements. Protection is desired for all changes and modifications that come within the spirit of the invention. Those skilled in the art will appreciate variations of the above-described embodiments that fall within the scope of the invention. As a result, the invention is not limited to the specific examples and illustrations discussed above, but only by the following claims and their equivalents.

What is claimed is:

1. Apparatus for use with a publicly accessible digital surface to provide collaborative data processing among a plurality of users of the digital surface, the apparatus comprising:
a personal digital device (PDD) adapted for storing and processing data for a user of the PDD, the PDD communicatively coupled with the digital surface; and
a stylus adapted for communication with the PDD and adapted for wireless communication with the digital surface, the stylus adapted to authenticate exchanges between the PDD and the shared digital surface initiated by the stylus in communications with the digital surface.

2. The PDD of claim 1
wherein the stylus further comprises:
a near field communication (NFC) device to identify the stylus to the digital surface, the digital surface adapted to associate the identity of the stylus with the PDD.

3. The PDD of claim 2
wherein the NFC device is a radio frequency identification (RFID) circuit.

4. The PDD of claim 2
wherein the NFC device is a barcode read by the digital surface.

5. The PDD of claim 1
wherein the stylus further comprises:
a wireless proximity communication device to identify the stylus to the digital surface, the digital surface adapted to associate the identity of the stylus with the PDD.

6. The PDD of claim 5
wherein the wireless proximity communication device is a Bluetooth circuit.

7. The PDD of claim 5
wherein the wireless proximity communication device is and IrDA circuit.

8. The PDD of claim 1
wherein the PDD is adapted to identify its user to the digital surface and to establish an security token associated with the user for use in further exchanges with the digital surface on behalf of the user of the PDD, and
wherein the stylus is adapted receive the security token from the PDD and is adapted to use the security token in subsequent exchanges with the digital surface on behalf of the user of the PDD.

9. The PDD of claim 8
wherein the security token is passed from the stylus of a first PDD to another PDD through the digital surface to authorize an exchange of information between the two PDDs.

10. The PDD of claim 8
wherein the stylus is adapted to periodically send the security token of the PDD to the digital surface,
wherein the digital surface is adapted to receive the security token from the stylus and is adapted to detect the location of the stylus on the digital surface, and
wherein the digital surface uses the security token and the location of the stylus to authenticate an action of the stylus at a location on the digital surface by the user associated with the security token.

11. The PDD of claim 10
wherein the action of the stylus includes one or more of: click, drag, drop, cut, copy and paste.

12. A method operable a personal digital device (PDD) and a digital surface, the method comprising:
communicatively coupling the PDD to the digital surface;
establishing between the PDD and the digital surface a security token associated with a session for exchange of information between the PDD and the digital surface;
providing the security token to a stylus device communicatively coupled with the PDD;
communicatively coupling the stylus with the digital surface;
receiving the security token at the digital surface from the stylus;
determining the location of the stylus on the digital surface; and
authenticating actions of the stylus communicated from the stylus to the digital surface using the location of the stylus and the security token received from the stylus.

13. The method of claim 12 further comprising:
allocating a workspace on the digital surface associated with the PDD.

14. The method of claim 13
wherein the step of communicatively coupling further comprises:
determining a location of the PDD relative to the digital surface, and
wherein the step of allocating a workspace further comprises:
allocating the workspace in a location on the digital display based on the location of the PDD relative to the digital display.

15. The method of claim 13
wherein the workspace defines a sphere of influence of the PDD with respect to the digital surface,
wherein the step of authenticating actions of the stylus further comprises:
authenticating actions of the stylus communicated from the stylus to the digital surface based on the proximity of the location of the stylus relative to the sphere of influence of the PDD.

16. The method of claim 13 further comprising:
communicatively coupling other PDDs to the digital surface; and
allocating other workspaces on the digital surface each associated with a corresponding one of the other PDDs wherein each workspace defines a corresponding sphere of influence associated with the corresponding one of the other PDDs,
wherein the step of authenticating actions of the stylus further comprises:
authenticating actions of the stylus communicated from the stylus to the digital surface based on the proximity of the location of the stylus relative to the sphere of influence of the PDD and relative to the sphere of influence associated with each of the other PDDs.

17. The method of claim 12
wherein the action of the stylus includes one or more of: click, drag, grab, drop, cut, copy and paste.

18. The method of claim 12
wherein the step of communicatively coupling the PDD with the digital surface further comprises:
coupling the PDD with the digital surface using a wireless coupling, and
wherein the step of communicatively coupling the stylus with the digital surface further comprises:
coupling the stylus with the digital surface using a wireless coupling.

19. A system comprising:
a digital surface adapted for wireless communication with a plurality of personal digital devices (PDDs) and adapted to display information exchanged between the digital surface and each of the plurality of PDDs;
at least one PDD adapted to store and process information on behalf of a user of the PDD wherein each PDD further comprises:
a stylus adapted for wireless communication with the digital surface and communicatively coupled to its associated PDD,
wherein the digital surface and each PDD are adapted to exchange information to establish a security token associated with said each PDD for exchanges of information among the plurality of PDDs through the digital surface,
wherein the stylus associated with each PDD is adapted to receive the security token from its associated PDD and is adapted to communicate the security token to the digital surface,
wherein the digital surface is adapted to detect the location on the digital surface of the stylus associated with each PDD and is adapted to receive the security token from the stylus associated with each PDD,
wherein the digital surface is adapted to receive actions from a stylus associated with each PDD and is adapted to authenticate a received action based on the location of the stylus and based on the security token received from the stylus.

20. The system of claim 19
wherein the digital surface further comprises:
a plurality of optical communication devices each adapted to exchange information at a location of the digital associated said each optical communication device,
wherein the each stylus further comprises:
an optical communication device to identify said each stylus to the digital surface, the digital surface adapted to associate the identity of said each stylus with its PDD based on information exchanged optically between the digital surface and said each stylus.

21. The system of claim 19
wherein each PDD includes one or more wireless communication devices including: IrDA, Bluetooth, RFID, and barcode.

22. The system of claim 19
wherein the digital surface is adapted to pass a security token from a first stylus of a first PDD to another PDD to authorize an exchange of information between the two PDDs.

23. The system of claim 19
wherein each stylus is adapted to periodically send its security token to the digital surface,
wherein the digital surface is adapted to receive the security token from each stylus and is adapted to detect the location of each stylus on the digital surface, and
wherein the digital surface uses the security token and the location of the stylus to authenticate an action of a stylus at a location on the digital surface by the user associated with the security token.

24. The system of claim 23
wherein the action of a stylus includes one or more of: click, drag, grab, drop, cut, copy and paste.

25. The system of claim 23
wherein the digital surface is adapted to establish a region of influence on the digital surface for each of the plurality of PDDs,

26. The system of claim 25
wherein the digital surface uses the security token and the location of a stylus and the region of influence of each PDD to authenticate an action of a stylus at a location on the digital surface by the user associated with the security token.
